(19) United States
(12) Patent Application Publication
(10) Pub. No.: US 2010/0154003 A1
(43) Pub. Date: Jun. 17, 2010

(54) PROVIDING REPORT OF POPULAR CHANNELS AT PRESENT TIME

(75) Inventors: Haifeng Bi, San Antonio, TX (US); Xiaolian Bi, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/333,013

(22) Filed: Dec. 11, 2008

(51) Int. Cl. H04N 5/445

(52) U.S. Cl. 725/46

(57) ABSTRACT

Users are provided real time reports of the most popular multimedia programs or channels. Users may select an information channel provided by a multimedia content distribution network that provides the report. User criteria may determine the organization of the report and the selection of elements for the report. For example, the top ten most popular multimedia programs or channels in a particular genre may be displayed in the report.

### BACKGROUND

1. Field of the Disclosure

The present disclosure generally relates to multimedia content distribution networks and more particularly to providing users access to reports regarding popular multimedia content.

2. Description of the Related Art

Multimedia programs may be received over a multimedia content distribution network (MCDN). In traditional systems, users of the MCDN may not know which multimedia programs or channels are popular.

### BRIEF DESCRIPTION OF THE DRAWINGS

FIG. 1 illustrates a representative Internet protocol television (IPTV) architecture for receiving multimedia programs and, in accordance with disclosed embodiments, providing reports of popular multimedia programs or channels;

FIG. 2 is a block diagram of selected elements of a set-top box (STB) 121 from FIG. 1 which may be used in accordance with disclosed embodiments to monitor local multimedia program selections and provide a report of popular multimedia programs or channels; and

FIG. 3 illustrates selected operations in a method for providing a report of popular multimedia programs or channels.

### DESCRIPTION OF EXEMPLARY EMBODIMENTS

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a large number of multimedia content channels (also referred to herein as “channels”), each occupying a different frequency band or frequency channel, through a coaxial cable, a fiber-optic cable, or a combination of the two. The bandwidth required to transport simultaneously a large number of multimedia channels may challenge the bandwidth capacity of cable-based networks. In these types of networks, a tuner within an STB, television, or other form of receiver is required to select a channel from the mixed signal for playing or recording. A user wishing to play or record multiple channels typically needs to have distinct tuners for each desired channel. This can be an inherent limitation of cable networks and other mixed signal networks.

In contrast to mixed signal networks, IPTV networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies to distribute multimedia content. Instead of being associated with a particular frequency band, an IPTV television program, movie, or other form of multimedia content is a packet-based stream that corresponds to a particular network endpoint, e.g., an IP address and a transport layer port number. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an indication of a network endpoint that is associated with the desired channel.

IPTV may be implemented, at least in part, over existing infrastructure including, for example, a proprietary network that may include existing telephone lines, possibly in combination with customer premises equipment (CPE) including, for example, a digital subscriber line (DSL) modem in communication with an STB, a display, a program rendering device, and other appropriate equipment to receive multimedia content and convert it into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as VOD, pay-per-view (PPV), advanced programming information (e.g., sophisticated and customizable electronic programming guides (EPGs), and the like. Bidirectional networks may also enable a service provider to collect information related to a user's preferences, whether for purposes of providing preference based features to the user, providing potentially valuable information to service providers, or providing potentially lucrative information to content providers and others.

Disclosed embodiments provide a real time report of multimedia program or channels that are tuned into by other viewers. Such reports may suggest to the user that the channels or multimedia programs appearing on the report may be of interest.

In one aspect, a disclosed service provides reports of popular channels. The service includes determining a quantity of current viewers for each of a plurality of channels, ranking the plurality of channels according to the determined quantities, and populating a report with indications of the channels and their respective rankings. A user may provide input to select a channel or program from the report, and in response the service provides the user with multimedia content for the selected channel. The report may include, without limitation, for each multimedia program or channel, the following information: selectable icons, screen shots, moving video images, program titles, rankings, ratings, and genres.

In another aspect, a disclosed ranking server includes a tangible computer readable medium with instructions for assimilating data indicating a quantity of viewers viewing a channel, creating ranking data by ranking the quantity of viewers relative to further quantities of viewers tuned to other channels, and reporting the ranking data in response to a user selecting an information channel. The channels are provided by a an MCDN (e.g., Internet protocol television network). In some embodiments, a report includes channels or multimedia programs organized by genres, appropriateness, quality, and the time remaining in the current program. The report may include ranking data used for organizing channels or multimedia programs according to the quantity of viewers relative to further quantities of viewers of other channels or multimedia programs. A CPE device (e.g., an STB) may be used for monitoring channels or multimedia programs selected by users. Periodically or in response to a network request, data obtained from the monitoring may be reported to the MCDN. The data from multiple CPE devices may be organized, summarized, and delivered back to individual CPE devices in response to a user requesting a real-time report of most popular channels.

In still another aspect, a disclosed process provides a report of popular multimedia programs and includes providing data indicative of a local program selection to an MCDN, receiving from the MCDN a plurality of indications of programs ranked according to popularity, and providing indication of the popularity in the report. The report is provided on an information channel and may rank multimedia programs or channels according to quality, appropriateness, or remaining times. The report may include video images, titles, and other information that may be obtained from metadata for the multimedia programs or channels. Further, the report may include a pie chart or a bar chart that visually compares the popularity of a plurality of multimedia programs or channels.

Below, exemplary embodiments are described in sufficient detail to enable one of ordinary skill in the art to practice the disclosed subject matter without undue experimentation. It should be apparent to a person of ordinary skill that the disclosed examples are not exhaustive of all possible embodiments. Regarding reference numerals used to describe elements in the figures, a hyphenated form of a reference numeral may refer to a specific instance of an element and an un-hyphenated form of the reference numeral may refer to the element generically or collectively. Thus, for example, element 121-1 refers to an instance of an STB, which may be referred to collectively as STBs 121 and any one of which may be referred to generically as an STB 121.

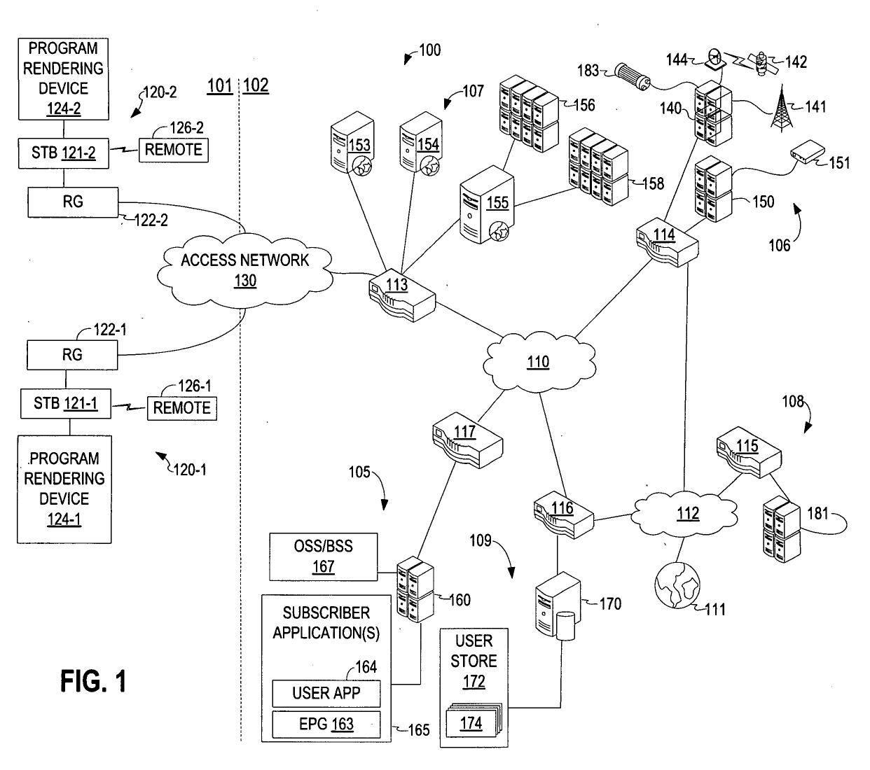

Referring now to the drawings, FIG. 1 illustrates selected aspects of an MCDN 100 for monitoring and reporting regarding most requested content. MCDN 100, as shown, is a multimedia content provider network that may be generally divided into a client side 101 and a service provider side 102 (a.k.a., server side 102). Client side 101 includes all or most of the resources depicted to the left of access network 130 while server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical cables that connect a subscriber's home or business to a local exchange. In these embodiments, the physical layer of access network 130 may include both twisted pair copper cables and fiber optics cables. In a fiber to the curb (FTTC) access network, the “last mile” portion that employs copper is generally less than approximately 300 feet in length. In fiber to the home (FTTH) access networks, fiber optic cables extend all the way to the premises of the subscriber.

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

Access network 130 may transmit radio frequency (RF) signals over coaxial cables. In these embodiments, access network 130 may utilize quadrature amplitude modulation (QAM) equipment for downstream traffic. Also in these embodiments, access network 130 may receive upstream traffic from a consumer's location using quadrature phase shift keying (QPSK) modulated RF signals.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements (e.g., emergency alert system messages) from local entities. The regional VHOs may then deliver the local and national content to users served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 may communicate over a public network 112, including, for example, an Internet or other type of Web network which is signified in FIG. 1 by the World Wide Web icon 111.

As shown in FIG. 1, client side 101 of MCDN 100 depicts two of a potentially large number of client side resources referred to herein simply as client(s) 120. Each client 120, as shown, includes an STB 121, a residential gateway (RG) 122, a program rendering device 124, and a remote control device 126. In the depicted embodiment, STB 121 communicates with server side devices through access network 130 via RG 122.

As shown in FIG. 1, RG 122 may include elements of a broadband modem (e.g., DSL modem or cable modem) and may communicate over wireless and/or wired interfaces. In addition, RG 122 may have elements of a firewall, router, switch, and access point for local area network (LAN) devices to communicate through wired and wireless (e.g., WiFi) Ethernet or other suitable networking technologies. In some embodiments, STB 121 is a uniquely addressable Ethernet compliant device. Program rendering device 124 may be, for example, any National Television System Committee (NTSC) and/or Phase Alternating Line (PAL) compliant program rendering device. Both STB 121 and program rendering device 124 may include any form of conventional frequency tuner.

In IPTV compliant implementations of MCDN 100, clients 120 are configured to receive packet-based multimedia streams from access network 130 and process the streams for presentation on program rendering devices 124. In addition, clients 120 are network-aware resources that may facilitate bidirectional-networked communications with server side 102 resources to support network hosted services and features. Because clients 120 are configured to process multimedia content streams while simultaneously supporting more traditional Web like communications, clients 120 may support or comply with a variety of different types of network protocols including streaming protocols such as real-time transport protocol (RTP) over user datagram protocol/Internet protocol (UDP/IP), as well as web protocols such as hypertext transport protocol (HTTP) over transport control protocol (TCP/IP).

The server side 102 of MCDN 100, as depicted in FIG. 1, emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down-linked signals transmitted by a satellite 142 and received by a parabolic dish 144. In addition, live acquisition server 140 may acquire programming feeds transmitted via high-speed fiber feed 183 or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. Live acquisition server 140 is communicatively coupled to an encoder which, prior to transmission, encodes acquired content using for example, Motion Picture Expert Group (MPEG) standards such as MPEG-2, MPEG-4, a Windows Media Video (WMV) family codec, or another suitable video codec.

Content delivery resources 107, as shown in FIG. 1, are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content according to the network communication protocol stack in use. These data packets are then transmitted across a network to a receiver (e.g., STB 121 of client 120), where the content is parsed from individual packets and re-assembled into multimedia content suitable for processing by a decoder.

User requests received by content delivery server 155 may include an indication of the content that is being requested. In some embodiments, this indication includes a network endpoint associated with the desired content. The network endpoint may include an IP address and a transport layer port number. For example, a particular local broadcast television station may be associated with a particular channel and the feed for that channel may be associated with a particular IP address and transport layer port number. When a user wishes to view the station, the user may interact with remote control device 126 to send a signal to STB 121 indicating a request for the particular channel. When STB 121 responds to the remote control signal, the STB 121 changes to the requested channel by transmitting a request that includes an indication of the network endpoint associated with the desired channel to content delivery server 155.

Content delivery server 155 may respond to such requests by making a streaming video or audio signal accessible to the user. Content delivery server 155 may employ a multicast protocol to deliver a single originating stream to multiple clients. When a new user requests the content associated with a multicast stream, there may be latency associated with updating the multicast information to reflect the new user as a part of the multicast group. To avoid exposing this undesirable latency to a user, content delivery server 155 may temporarily unicast a stream to the requesting user. When the user is ultimately enrolled in the multicast group, the unicast stream is terminated and the user receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations. To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including RTP, real-time control protocol (RTCP), file transfer protocol (FTP), and real-time streaming protocol (RTSP).

In some embodiments, client-facing switch 113 routes multimedia content encapsulated into IP packets over access network 130. For example, an MPEG-2 transport stream may be sent in which the transport stream consists of a series of 188-byte transport packets. In some embodiments, the MPEG-2 transport stream may include reports of popular channels or multimedia programs for a presentation on a user's program rendering device, in accordance with disclosed embodiments. Client-facing switch 113, as shown, is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153, and client gateway 153 may then allow such devices to access private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167, which may translate a query to the OSS/BSS server 181. Upon client gateway 153 confirming subscriber and/or billing information, client gateway 153 may allow STB 121 access to IPTV content, VOD content, and other services. If client gateway 153 cannot verify subscriber information (i.e., user information) for STB 121, for example, because it is connected to an unauthorized local loop or RG, client gateway 153 may block transmissions to and from STB 121 beyond access network 130.

MCDN 100, as depicted, includes application resources 105, which communicate with private network 110 via application switch 117. Application resources 105, as shown, include application server 160 which is operable to host or otherwise facilitate one or more subscriber applications 165 that are made available to system subscribers. For example, subscriber applications 165, as shown, include EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a user, who may be a subscriber to a service provided by MCDN 100. For example, in accordance with disclosed embodiments, user application 164 may be an application that monitors requests (e.g., channel selections or multimedia program selections) for multimedia content and provides reports of most popular multimedia programs or channels to users. User application 164, as illustrated in FIG. 1, emphasizes the ability to extend the network's capabilities by implementing a network-hosted application. Because user application 164 may reside on the network, it generally does not impose any significant requirements or imply any substantial modifications to client 120 including STB 121. In some instances, an STB 121 may require knowledge of a network address associated with user application 164, but STB 121 and the other components of client 120 are largely unaffected.

As shown in FIG. 1, application server 160 may be implemented as a ranking server that monitors requests (e.g., channel selections or multimedia program selections) for multimedia content and provides reports of most popular multimedia programs or channels to users. Accordingly, subscriber applications 165 are stored on at least one tangible computer readable medium and user application 164 includes machine executable instructions for assimilating data indicating a quantity of viewers viewing a channel provided by MCDN 100, creating ranking data by ranking the quantity of viewers relative to further quantities of viewers tuned to other channels provided by MCDN 100, and reporting the ranking data in response to a user selecting an information channel (e.g., channel 100). In some embodiments, user application 164 includes instructions for transporting the ranking data from the multimedia content distribution network to a CPE device (e.g., STB 121). The report may be organized by user application 164 according to genre (e.g., action), appropriateness ratings (e.g., suitable for all ages), or quality (e.g., four stars out of five stars as rated by other users of MCDN 100). In some embodiments, multimedia programs or channels in the report may be associated with remaining times (e.g., thirty minutes remaining in the broadcast) for receiving the content. For example, a report may indicate that a movie currently showing on a ranked channel has two hours remaining for viewing.

As shown in FIG. 1, a database switch 116, as connected to applications switch 117, provides access to database resources 109. Database resources 109 include database server 170 that manages a system storage resource 172, also referred to herein as user store 172. User store 172, as shown, includes one or more user profiles 174 where each user profile includes account information and may include preferences information that may be retrieved by applications executing on application server 160 including user applications 165.

As shown in FIG. 1, MCDN 100 implements a service that provides users with a report of popular channels. The service includes determining a quantity of current viewers for each of a plurality of channels, ranking the plurality of channels according to the determined quantities, populating the report with indications of a portion of the plurality of channels and their respective rankings, and displaying the report. The ranking of the channels may be responsive to a user selecting an information channel (e.g., channel 100). In some embodiments, the disclosed service provided by MCDN 100 includes providing the user with multimedia content for the selected channel in response to user input selecting a ranked channel from the report. For example, a user of STB 121-2 may be presented on program rendering device 124-2 with a report of the ten most popular channels currently viewed by other users of MCDN 100. The report may include indications of sporting events, music videos, video on-demand multimedia programs, or other forms of multimedia content provided by MCDN 100. The report may include a list of multimedia program titles, video images, appropriateness data, titles, genres, and other information related to multimedia programs that are ranked in the report. The report may also include selectable icons corresponding to the most popular channels. In response to user input to select one of the selectable icons, MCDN 100 may provide the user of STB 121-2 with access to corresponding multimedia content.

To contribute to the disclosed service, STB 121-2 may provide components of MCDN 100 (e.g., user application 164) with indications of currently selected channels. User application 164 may also receive indications from other STBs (e.g., STB 121-1) and CPE devices regarding content that is currently received by STBs or CPE devices. A report summarizing the most popular channels or multimedia programs may then be disseminated to the STBs or CPE devices over access network 130 or other communication channels.

The disclosed service may include receiving user input defining criteria for organizing indications of the channels or multimedia programs in the report. The criteria may be provided using remote control device 126 which, as shown, is communicatively coupled to STB 121. The user input may also be provided using a PC (not depicted) or other data processing system (e.g., smart phone) which may be communicatively coupled to STB 121. If necessary, STB 121 may relay the criteria through RG 122, over access network 130, and to any network-based component (e.g., user application 164) that needs the user defined criteria for reporting the popular channels or multimedia programs. User input that defines criteria for organizing the report may also be provided through a web portal accessed by STB 121, by a wireless telephony device (e.g., smart phone), or by a PC (not depicted) communicatively coupled to client 120 or one or more elements of server side 102.

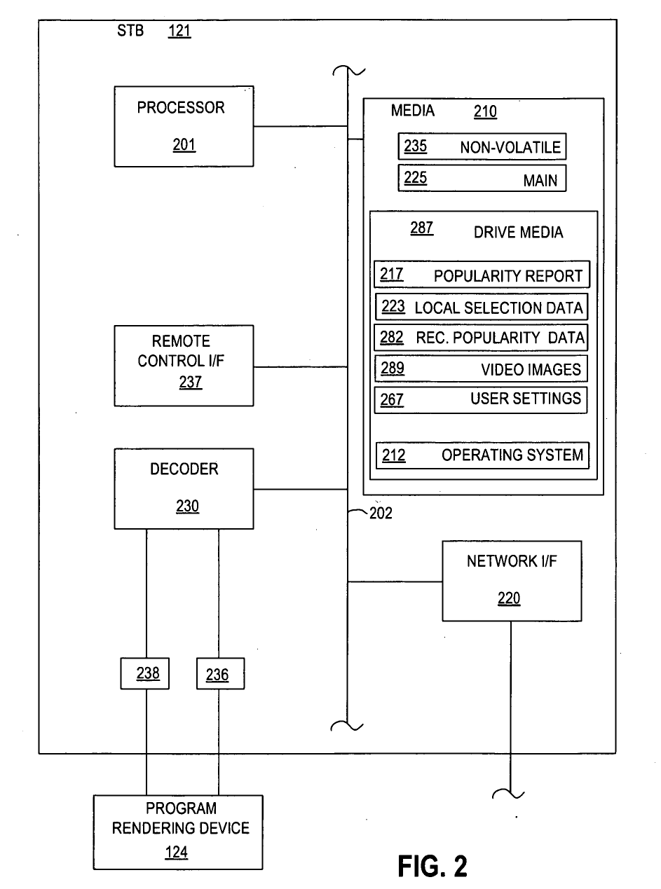

Referring to FIG. 2, a block diagram illustrating selected elements of STB 121 is presented. In the depicted embodiment, STB 121 includes a processor 201 communicatively coupled to media 210 via a shared bus 202. Media 210 may include non-volatile media 235 and main media 225. Media 210 is operable to store instructions, data, or both. Media 210 as shown includes multiple sets or sequences of instructions, namely, operating system 212, user settings 267, video images 289, received popularity data 282, local selection data 223, and popularity report 217. Operation system 212 may be a Unix® or Unix-like operating system, a Windows® family operating system, or another suitable operating system.

STB 121 as depicted in FIG. 2 further includes a network adapter 220 that interfaces STB 121 to access network 130 (FIG. 1), possibly through a residential gateway (e.g., RG 122 in FIG. 1). STB 121 in FIG. 2 may be similar to or identical to STB 121 in FIG. 1 and receive multimedia content such as television content from access network 130 (FIG. 1). In embodiments suitable for use in IP based content delivery networks, STB 121 may include an audio/video (A/V) decoder 230 that assembles payloads from a sequence or set of network packets into a stream of multimedia content. The stream of multimedia content may include audio information and video information and A/V decoder 230 may parse or segregate the two to generate a video stream 238 and an audio stream 236 as shown. Reports of the most popular channels or multimedia programs of MCDN 100 (FIG. 1) may be encoded in video stream 238 for presentation on program rendering device 124.

Video and audio streams 238 and 236, as output from A/V decoder 230, may include audio or video information that is compressed, encrypted, or both. A/V decoder 230 may employ any video decoding algorithm including for example without limitation: H.263, H.264, any of the MPEG standards, or WMV standards including WMV 9. Similarly, decoder 230 may employ any audio decoding algorithm including for example without limitation: Dolby® Digital, Digital Theatre System (DTS) Coherent Acoustics, and Windows Media Audio (WMA). The video and audio streams 238 and 236, as shown in FIG. 1, are processed by A/V decoder 230 to a format compliant with program rendering device 124, which itself may not be a part of STB 121. Program rendering device 124 may comply with NTSC, PAL or any other suitable television standard.

As shown in FIG. 2, media 210 is a tangible computer readable medium that includes instructions for providing to an MCDN (e.g., MCDN 100 in FIG. 1) data from local channel selections. User input to select a channel or multimedia program may be provided through remote control interface 237 through, for example, an “up channel” or “down channel” command. Accordingly, remote control interface 237 is enabled to receive IR signals, radio signals, or other communication signals from a remote control device (e.g., remote control device 126 in FIG. 1). Data related to local program selections are stored as local selection data 223 and may be transmitted during viewing to a network device (e.g., within MCDN 100) to provide data for presenting real time reports of popular channels. In alternate embodiments, data related to requests to receive multimedia programs may be collected from server side components and stored in a networked device (e.g., a ranking server) and used for providing real time reports of popular channels. Responsive to local user input received over remote control interface 237 for example, STB 121 receives from an MCDN (e.g., MCDN 100 in FIG. 1) over network interface 220 a plurality of indications of programs ranked according to popularity. Popularity is determined according to the viewership (i.e., the number of users of an MCDN that are tuned to a channel or multimedia program). The data with the programs ranked according to popularity is stored as received popularity data 282 and sent to a network ranking server. In addition to storage of popularity data, video images for the ranked multimedia programs or channels may be stored as video images 289. In some embodiments, streaming video images are stored. In other embodiments, still images may be stored as video images 289 and presented in the report.

User settings 267 as shown includes user configurable parameters for organizing reports. For example, a user may set parameters that indicate that a report should include only channels or multimedia programs that contain certain content (e.g., content suitable for all audiences) or that are in a particular language (e.g., English). A report of the most popular channels or multimedia programs is stored as popularity report 217 and presented to the user, in some disclosed embodiments, by the user selecting an information channel (e.g., channel 100). The report is encoded in video stream 236 and/or audio stream 238 for presentation on program rendering device 124. The report contains indications (e.g., titles, icons, etc.) of multimedia programs or channels. In some cases, the report includes selectable icons associated with popular channels or multimedia programs that are available. In response to user selection of one of the icons, the corresponding channel or multimedia program is provided by STB 121 to the user (i.e., to program rendering device 124).

STB 121 contributes to popularity data and reports regarding local selections of channels and multimedia programs. Accordingly, STB 121 stores local selection data 223 and from time to time sends the data to a network element (e.g., a ranking server within an MCDN) over network interface 220. Local selection data 223 may be sent to the MCDN periodically, in response to a network request, according to a schedule, or otherwise as appropriate or necessary.

In addition to STB 121 contributing to popularity data that may be used by ranking servers and other STBs, STB 121 may update reports in real time in response to a change of popularity as evidenced by newly received popularity data. Accordingly, STB 121 may update in real-time received popularity data 282 and adjust popularity report 217 if necessary to provide timely and accurate popularity data. In some embodiments, updating a displayed popularity report is in response to a user request (e.g., received over remote control interface 237) to refresh the popularity report.

Reports may be displayed and organized according to user settings 267. For example, user settings 267 may specify that reports contain video images (e.g., streaming video) from programs. In addition, the report may include, according to user settings 267, a pie chart that compares the popularity of a number (e.g., ten) of channels. Alternatively, user settings 267 may specify that the report include a bar chart that illustrates the popularity of a number (e.g., ten) of channels.

In some emobiments, local selection data 223 only registers a program selection if minimum duration criteria are met. For example, data for a channel selection may only be stored into local selection data 223 and sent to a network ranking server if a viewer has been watching a channel for five minutes. Also, channel selection data stored within local selection data 223 and stored within ranking servers may be purged after its age reaches a configurable retention period. The retention period and the minimum duration criteria may be stored within user settings 267. The retention period and the minimum duration criteria may be preconfigured by developers of STB 121, may be provided with user input, or may be provided through administrator input.

In response to a user request to view a report, STB 121 encodes the report with video stream 238 and/or audio stream 236 for presentation by program rendering device 124. The displayed report includes indications (e.g., text, icons, video clips, screen shots, photographs, synthesized voice output, metadata, and avatars) of the most popular channels or multimedia programs.

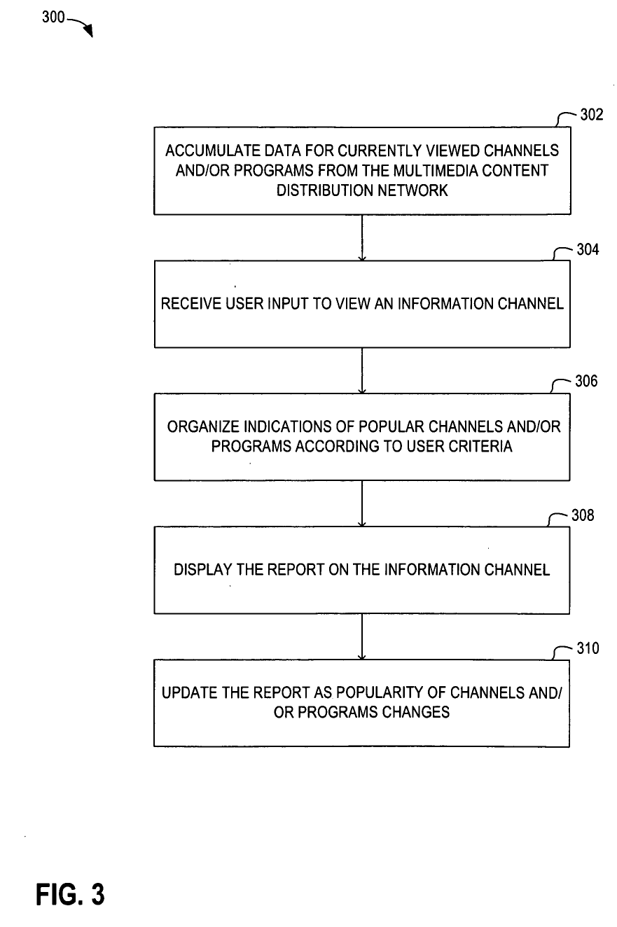

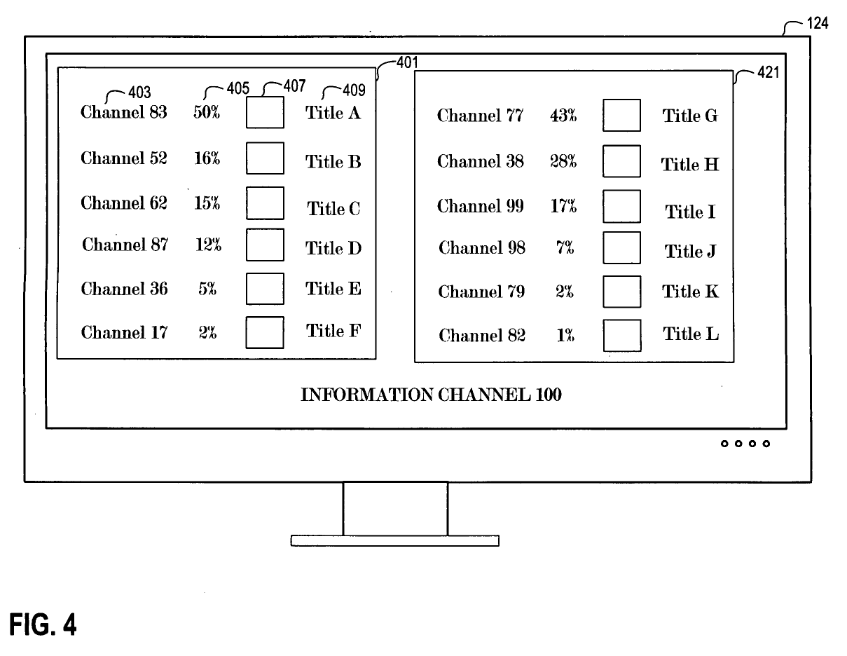

As shown, FIG. 3 illustrates a method 300 for providing a report of popular channels or multimedia programs in accordance with disclosed embodiments. As shown, method 300 includes accumulating (block 301) data for currently viewed channels and/or multimedia programs that are received from an MCDN. Method 300 includes receiving (block 304) user input to view an information channel that contains a report of popular channels and/or multimedia programs. Popular channels and/or programs in the report are organized (block 306) according to user criteria such as top ten sports events, top five comedy channels, and the like. The report is displayed (block 308) on the information channel and is optionally updated (block 310) as the popularities of the channels and/or programs changes.

FIG. 4 illustrates program rendering device 124 that includes a report 401 with channel data 403, ranking data 405, video images 407, title data 409. Report 401 may also include data related to the time remaining for ranked channels. For example, report 401 may include a channel identifier, a multimedia program title, a streaming video image, ranking data, and a remaining time of thirty minutes for a multimedia program associated with (i.e., available for viewing on) the most popular channel at the present time. Report 401 represents data for a first category of channels or multimedia programs in which the category may selected by user input (e.g., user settings 267 from FIG. 2). The first category may be a genre (e.g., sports), appropriateness level (e.g., rated PG as requiring parental guidance), or quality level (e.g., rated four stars out of five). Report 421 as shown includes a second category set by user criteria. For example, report 401 may include a first category that is “movies” and report 421 may include a second category that is “sports events.”

Ranking data 405 in report 401 is shown as a percentage of viewers watching the seven channels indicated in the report. Video images 407 may include still images, streaming video, program advertisement images, trademarks, and the like. Video images 407 and other elements within reports 401 and 421 may be selectable to allow a user request to receive the associated multimedia program or channel.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A service for providing a report of popular channels, the service comprising:
determining a quantity of current viewers for each of a plurality of channels;
ranking the plurality of channels according to the determined quantities;
responsive to a user selecting an information channel, populating the report with indications of a portion of the plurality of channels and their respective rankings; and
displaying the report.

2. The service of claim 1, further comprising:
responsive to user input selecting a ranked channel from the report, providing the user with multimedia content for the selected channel.

3. The service of claim 1, wherein the report includes a list of multimedia content titles.

4. The service of claim 3, wherein the report includes a video image from multimedia content available from a ranked channel in the report.

5. The service of claim 3, wherein the report includes a selectable channel icon, wherein the channel icon corresponds to a ranked channel in the report.

6. The service of claim 1, further comprising:
receiving from a customer premises equipment device an indication of a currently selected channel.

7. The service of claim 6, wherein said receiving comprises:
receiving from a plurality of customer premises equipment devices respective indications of currently selected channels; and
disseminating the report.

8. A ranking server comprising:
at least one tangible computer readable medium including machine executable instructions for:
assimilating data indicating a quantity of viewers viewing a channel provided by a multimedia content distribution network;
creating ranking data by ranking the quantity of viewers relative to further quantities of viewers tuned to other channels provided by the multimedia content distribution network; and
reporting the ranking data in response to a user selecting an information channel.

9. The ranking server of claim 8, wherein said providing includes transporting the ranking data from the multimedia content distribution network to a customer premises equipment device.

10. The ranking server of claim 8, wherein said reporting includes organizing the ranking data according to genres.

11. The ranking server of claim 8, wherein said reporting includes organizing the ranking data according to appropriateness ratings.

12. The ranking server of claim 8, wherein said reporting includes organizing the ranking data according to quality ratings.

13. The ranking server of claim 8, wherein said reporting includes reporting remaining times for receiving multimedia programs associated with reported ranking data.

14. A process for providing a report of popular programs, the process comprising:
providing to a multimedia content distribution network selection data that is indicative of a local program selection;
responsive to a local user input to receive an information channel, receiving from the multimedia content distribution network a plurality of indications of programs ranked according to popularity, wherein popularity is determined according to viewership,
providing a portion of the indications in the report.

15. The process of claim 14, wherein the portion of indications of programs are individually selectable, the process further comprising:
responsive to a user selection of an indication of a program, providing the program to the user.

16. The process of claim 14, wherein said providing the portion of the indications includes updating the provided indications in real time in response to a change in popularity.

17. The process of claim 14, wherein the report includes an array of the indications of channels.

18. The process of claim 14, wherein the report includes video images from programs represented by the indications.

19. The process of claim 14, wherein said providing comprises providing a pie chart based on the indications.

20. The process of claim 14, wherein said providing comprises providing a bar chart based on the indications.
